(19) United States
(12) Patent Application Publication
(10) Pub. No.: US 2012/0167218 A1
(43) Pub. Date: Jun. 28, 2012

(54) SIGNATURE-INDEPENDENT, SYSTEM BEHAVIOR-BASED MALWARE DETECTION

(76) Inventors: Rajesh Poornachandran, Beaverton, OR (US); Selim Aissi, Beaverton, OR (US)

(21) Appl. No.: 12/978,043

(22) Filed: Dec. 23, 2010

(51) Int. Cl. G06F 11/00

(52) U.S. Cl. 726/24

(57) ABSTRACT

A method, system, and computer program product for detecting malware based upon system behavior. At least one process expected to be active is identified for a current mode of operation of a processing system comprising one or more resources. An expected activity level of the one or more resources of the processing system is calculated based upon the current mode of operation and the at least one process expected to be active. An actual activity level of the plurality of resources is determined. If a deviation is detected between the expected activity level and the actual activity level, a source of unexpected activity is identified as a potential cause of the deviation. Policy guidelines are used to determine whether the unexpected activity is legitimate. If the unexpected activity is not legitimate, the source of the unexpected activity is classified as malware.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### TECHNICAL FIELD

The present disclosure relates generally to malware detection in data processing systems.

### BACKGROUND

With the proliferation of mobile devices in today's society, applications running in mobile computing environments are increasing in number and sophistication. Mobile devices are now being used to process highly sensitive transactions such as financial/banking transactions, health and wellness monitoring, payment processing, and social networking. These highly sensitive transactions make mobile devices an attractive target for hackers and malware. Because of the small form factor that limits the computing resources, storage, and battery life available to a mobile device, traditional anti-virus techniques are of limited usefulness on a mobile device.

### BRIEF DESCRIPTION OF THE DRAWINGS

FIG. 1 is a block diagram of a system configured to enable signature-independent system behavior-based malware detection in accordance with one embodiment of the invention.

FIG. 2 is a detailed block diagram of the system of FIG. 1 in accordance with one embodiment of the invention.

FIG. 3 is a flowchart of a method for performing signature-independent system behavior-based malware detection in accordance with one embodiment of the invention.

FIG. 4 is a flowchart of a method for monitoring new applications invoked by the user while the system is in operation in accordance with one embodiment of the invention.

### DETAILED DESCRIPTION

Embodiments of the present invention may provide a method, system, and computer program product for performing signature-independent system behavior-based malware detection. In one embodiment, the method includes identifying at least one process expected to be active for a current mode of operation of a processing system comprising one or more resources; calculating an expected activity level of the one or more resources of the processing system based upon the current mode of operation and the at least one process expected to be active; determining an actual activity level of the plurality of resources; if a deviation is detected between the expected activity level and the actual activity level, identifying a source of unexpected activity as a potential cause of the deviation; using policy guidelines to determine whether the unexpected activity is legitimate; and classifying the source of the unexpected activity as malware if the unexpected activity is not legitimate.

The method may further include sending a snapshot of the processing system to a remote server, wherein the remote server performs validation of the snapshot and/or analyzes the snapshot for virus signatures. The method may further include terminating the source of the unexpected activity. In one embodiment, the method includes identifying a change in the current mode of operation of the processing system to a new mode of operation; identifying a second at least one process expected to be active; and adjusting the expected activity level based upon the new mode of operation and the second at least one process expected to be active. In one embodiment, using the policy guidelines to determine whether the unexpected activity is legitimate comprises determining whether the source is signed. Using the policy guidelines to determine whether the unexpected activity is legitimate may further include alerting a user of the unexpected activity and obtaining feedback from the user about the unexpected activity.

Reference in the specification to “one embodiment” or “an embodiment” of the present invention means that a particular feature, structure or characteristic described in connection with the embodiment is included in at least one embodiment of the invention. Thus, the appearances of the phrases “in one embodiment,” “according to one embodiment” or the like appearing in various places throughout the specification are not necessarily all referring to the same embodiment.

For purposes of explanation, specific configurations and details are set forth in order to provide a thorough understanding of the present invention. However, it will be apparent to one of ordinary skill in the art that embodiments of the present invention may be practiced without the specific details presented herein. Furthermore, well-known features may be omitted or simplified in order not to obscure the present invention. Various examples may be given throughout this description. These are merely descriptions of specific embodiments of the invention. The scope of the invention is not limited to the examples given.

In traditional desktop systems, many users install anti-virus software that can detect and eliminate known viruses after the computer downloads or runs the executable. There are two common methods that an anti-virus software application uses to detect viruses. The first, and most common, method of virus detection is using a list of virus signature definitions. This technique works by examining the content of the computer's memory (its RAM, and boot sectors) and the files stored on fixed or removable drives (hard drives, floppy drives), and comparing those files against a database of known virus “signatures”. One disadvantage of this detection method is that users are only protected from viruses that pre-date their last virus definition update. Another disadvantage is that significant resources are needed to store the database of virus signatures, which can have millions of entries, thereby exceeding the amount of storage available on a mobile device.

The second method of virus detection is to use a heuristic algorithm to find viruses based on common behaviors exhibited by virus software. This method has the ability to detect novel viruses for which a signature has yet to be created but requires that the common behaviors exhibited by virus software be identified in advance. This technique also has the disadvantage that extensive computing resources are required to identify and track common behaviors, and these extensive computing resources may not be available on a mobile device.

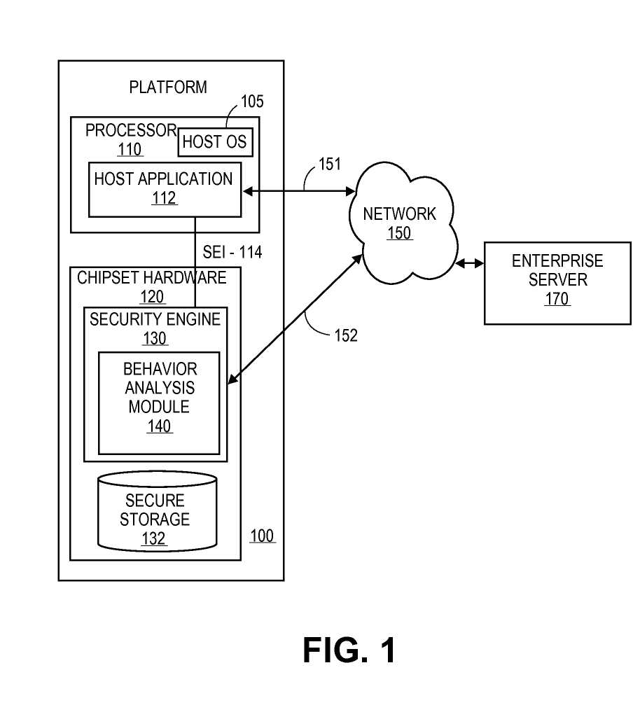

FIG. 1 is a block diagram of a system configured to perform signature-independent system behavior-based malware detection in accordance with one embodiment of the invention. Platform 100, which corresponds to a mobile computer system and/or mobile telephone, includes a processor 110 connected to a chipset 120. Processor 110 provides processing power to platform 100 and may be a single-core or multi-core processor, and more than one processor may be included in platform 100. Processor 110 may be connected to other components of platform 100 via one or more system buses, communication pathways or mediums (not shown). Processor 110 runs host applications such as host application 112, which communicates via interconnection 151 through network 150 to enterprise server 170. Host application 112 runs under the control of a host operating system 105.

Chipset 120 includes a security engine 130, which may be implemented as an embedded microprocessor that operates independently of processor 110, to manage the security of platform 100. Security engine 130 provides cryptographic operations and other user authentication functionality. In one embodiment, processor 110 operates under the direction of a host operating system 105, whereas security engine 130 provides a secure and isolated environment that cannot be accessed by the host operating system 105. This secure environment is referred to herein as a secure partition. The secure environment also includes secure storage 132.

In one embodiment, a behavior analysis module 140 running in security engine 130 is used by host application 112 to provide signature-independent system behavior-based malware detection. Host application 112 requests services of security engine 130, including signature-independent system behavior-based malware detection, via security engine interface (SEI) 114. Behavior analysis module 140 may be implemented as firmware executed by security engine 130.

Communication between security engine 130 and enterprise server 170 occurs via out-of-band communication channel 152. In one embodiment, out-of-band communication channel 152 is a secure communication channel between security engine 130 on the host system and enterprise server 170. Out-of-band communication channel 152 enables security engine 130 to communicate with external servers independently of the host operating system 105 of platform 100.

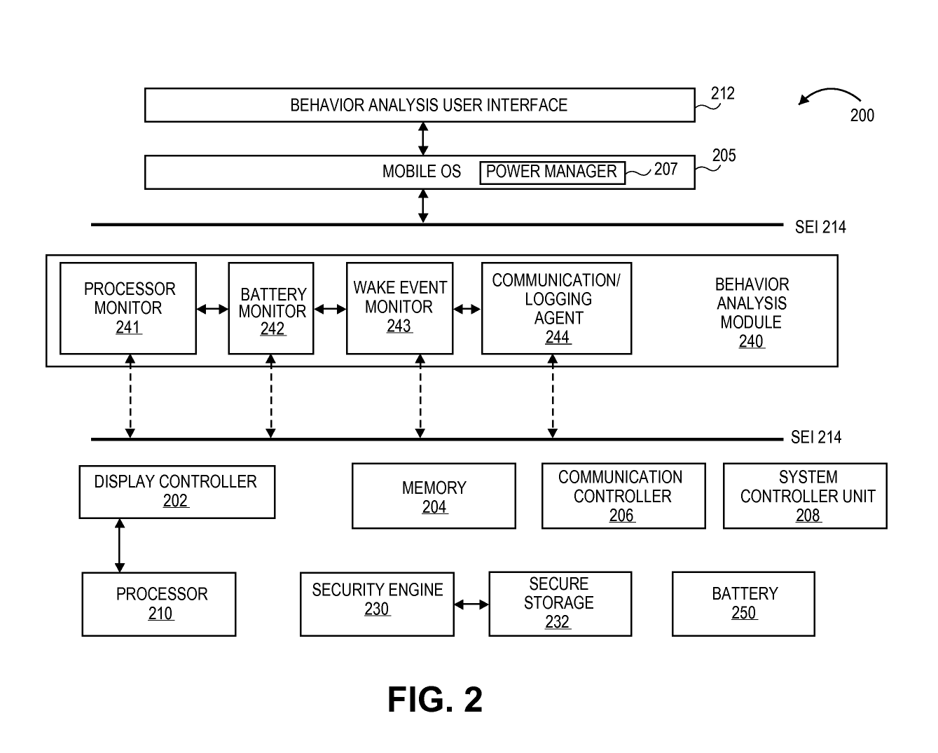

FIG. 2 shows a more detailed view of the components of the system of FIG. 1. In the embodiment shown in FIG. 2, a behavior analysis user interface 212 is a host application running in the environment provided by mobile operating system (OS) 205. Behavior analysis module user interface 212 calls behavior analysis module 240 to provide signature-independent system behavior-based malware detection. The interaction between behavior analysis module user interface 212 and behavior analysis module 240 is implementation-specific and may occur directly or via the mobile OS 205. In one embodiment, behavior analysis module user interface 212 provides an option to override dynamic settings of behavior analysis module 240.

Mobile OS 205 includes power manager 207, which suspends platform 200 subsystems during idle periods and increases the amount of time that processor 210 operates in a low power state. Power manager 207 keeps processor 210 in the lowest possible power state to increase power savings for mobile device 200.

Because behavior analysis module 240 runs within Security Engine 230, behavior analysis module 240 is accessed via Security Engine Interface (SEI) 214. Behavior analysis module 240 contains several sub-modules, including processor monitor 241, battery monitor 242, wake event monitor 243, and communication/logging agent 244.

Processor monitor 241 provides processor usage information to behavior analysis module 240. Processor monitor 241 monitors processor usage by interfacing with a kernel governor/menu (not shown). Processor monitor 241 also allows processes to be run at restricted privileges and/or frequencies.

Battery monitor 242 provides battery usage information to behavior analysis module 240. Battery usage is monitored to detect excessive non-processor resource utilization. For example, battery monitor 242 may detect excessive use of a graphics engine resource or an audio subsystem. Battery monitor 242 monitors battery usage by interfacing with a driver (not shown) for battery 250.

Wake event monitor 243 works with System Controller Unit (SCU) 208 and monitors for wake events. Wake event monitor 243 configures SCU 208 registers to filter unexpected wake events for a given mode of operation. System Controller Unit (SCU) 208 provides fine-grained platform power management support. Platform 200 wake events are routed to wake event monitor 243 via SCU 208.

When behavior analysis module 240 is invoked, it loads policy settings from secure storage 232. Behavior analysis module 240 obtains the current platform mode of operation from mobile OS 205 power manager 207. Examples of platform modes of operation include browsing, video/audio playback, camera, phone, and so on. Based upon the current mode of operation, behavior analysis module 240 identifies at least one process expected to be active. For example, during audio playback mode, an audio subsystem process is expected to be active, with the processor expected to be involved only for setting up and cleaning buffers.

Behavior analysis module 240 monitors activity levels of resources in platform 200 and compares the actual activity levels to expected activity levels. Expected activity levels are determined based upon the mode of operation of the system and the processes expected to be active in that mode of operation. For example, processor monitor 241 interfaces with a kernel processor menu/governor (not shown) to determine the expected activity level of processor 210 and battery 250 in the current mode of operation. The actual level of activity of processor 210 and battery 250, as well as the number and type of wake events handled by System Controller Unit (SCU) 208, is then monitored. If a deviation between the actual activity level and the expected activity level is found, a source of unexpected activity is identified as a potential cause of the deviation.

The source of unexpected activity is identified by behavior analysis module 240 by working with the kernel scheduler (not shown) to identify the currently active processes in the system. These currently active processes are mapped to applications that are currently expected to be running in the platform's current mode of operation. If an active process cannot be mapped to an expected application for the current mode of operation, that active process and its associated application are identified as the source of unexpected activity.

Once the source of unexpected activity is identified, behavior analysis module 240 uses policy guidelines to determine whether the unexpected activity is legitimate. For example, policy guidelines may be configured such that an application must be signed in order to be considered legitimate. Policy guidelines may be configured such that a user is alerted about the unexpected activity and user feedback is obtained to determine whether the application is legitimate.

If the unexpected activity is determined to be not legitimate, the source of unexpected activity may be classified as malware. Policy guidelines may be used to determine how to address the malware; for example, the source of the unexpected activity may be terminated and/or a snapshot may be taken of the system for further analysis. For example, a snapshot of the system may be sent to a remote server for analysis. The remote server may perform validation of the snapshot and/or analyze the snapshot for virus signatures.

Behavior analysis module 240 may be notified by mobile OS 205 power manager 207 when there is a change in the platform 200 mode of operation. For example, if platform 200 is in audio playback mode initially and the user invokes a browser, the system would change to a “browser+audio playback” mode of operation. Based upon the notification from mobile OS 205 power manager 207, behavior analysis module 240 would adjust its settings and expected activity level to avoid triggering false alarms.

Communication/logging agent 244 logs snapshots of the state of the system periodically and may transmit this information to a remote server such as enterprise server 170 of FIG. 1 for verification and/or analysis purposes. In sending the logged information, communication/logging agent 244 establishes a secure communication channel with enterprise server 170. Information captured in snapshots is implementation-specific and may include statistics of abnormal activity detected, identification of and/or code for unsigned applications running, the user's device usage pattern, logs of attempts to override privilege settings, and logs of unusual behavioral patterns.

Platform 200 further includes memory devices such as memory 204 and secure storage 232. These memory devices may include random access memory (RAM) and read-only memory (ROM). For purposes of this disclosure, the term “ROM” may be used in general to refer to non-volatile memory devices such as erasable programmable ROM (EPROM), electrically erasable programmable ROM (EEPROM), flash ROM, flash memory, etc. Secure storage 232 may include mass storage devices such as integrated drive electronics (IDE) hard drives, and/or other devices or media, such as floppy disks, optical storage, tapes, flash memory, memory sticks, digital video disks, biological storage, etc. In one embodiment, secure storage 232 is eMMC NAND flash memory embedded within chipset 220, which is isolated from mobile OS 205.

Processor 210 may also be communicatively coupled to additional components, such as display controller 202, small computer system interface (SCSI) controllers, network controllers such as communication controller 206, universal serial bus (USB) controllers, input devices such as a keyboard and mouse, etc. Platform 200 may also include one or more bridges or hubs, such as a memory controller hub, an input/output (I/O) controller hub, a PCI root bridge, etc., for communicatively coupling various system components. As used herein, the term “bus” may be used to refer to shared communication pathways, as well as point-to-point pathways.

Some components, such as communication controller 206 for example, may be implemented as adapter cards with interfaces (e.g., a PCI connector) for communicating with a bus. In one embodiment, one or more devices may be implemented as embedded controllers, using components such as programmable or non-programmable logic devices or arrays, application-specific integrated circuits (ASICs), embedded computers, smart cards, and the like.

As used herein, the terms “processing system” and “data processing system” are intended to broadly encompass a single machine, or a system of communicatively coupled machines or devices operating together. Example processing systems include, without limitation, distributed computing systems, supercomputers, high-performance computing systems, computing clusters, mainframe computers, mini-computers, client-server systems, personal computers, workstations, servers, portable computers, laptop computers, tablets, telephones, personal digital assistants (PDAs), handheld devices, entertainment devices such as audio and/or video devices, and other devices for processing or transmitting information.

Platform 200 may be controlled, at least in part, by input from conventional input devices, such as keyboards, mice, touch screens, voice-activated devices, gesture-activated devices, etc., and/or by commands received from another machine, biometric feedback, or other input sources or signals. Platform 200 may utilize one or more connections to one or more remote data processing systems, such as enterprise server 170 of FIG. 1, such as through communication controller 206, a modem, or other communication ports or couplings.

Platform 200 may be interconnected to other processing systems (not shown) by way of a physical and/or logical network, such as a local area network (LAN), a wide area network (WAN), an intranet, the Internet, etc. Communications involving a network may utilize various wired and/or wireless short range or long range carriers and protocols, including radio frequency (RF), satellite, microwave, Institute of Electrical and Electronics Engineers (IEEE)802.11, Bluetooth, optical, infrared, cable, laser, etc.

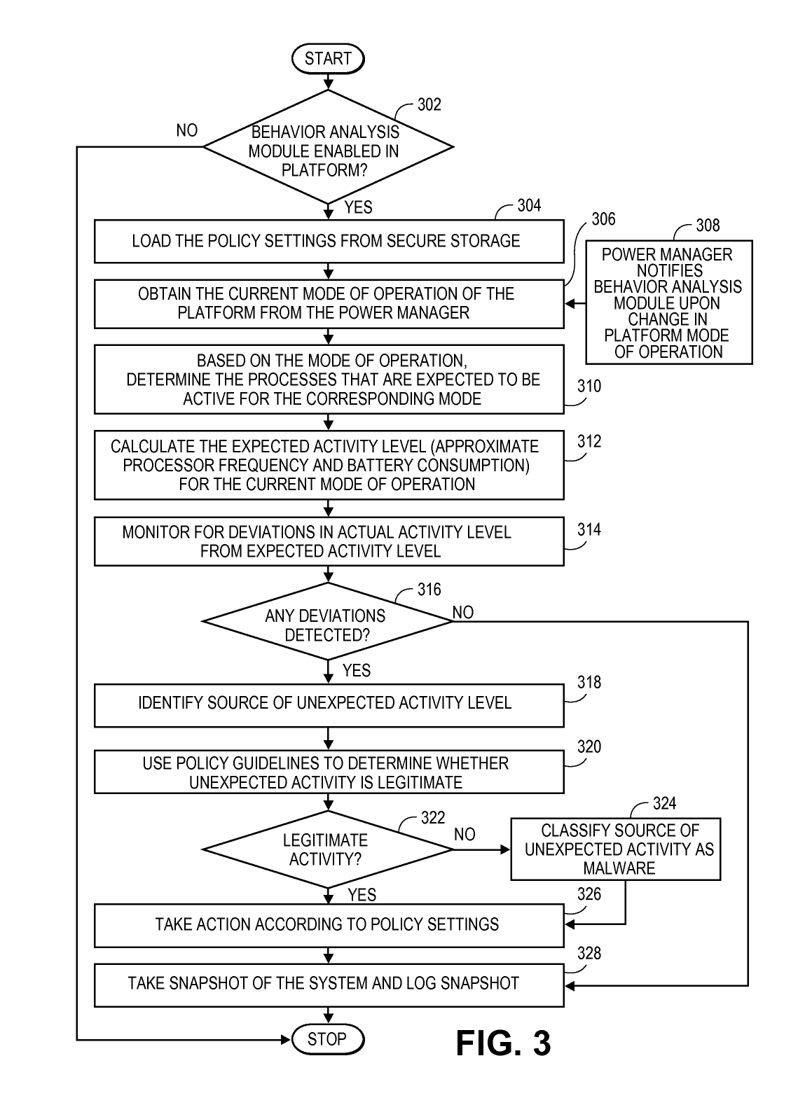

FIG. 3 is a flowchart of a method for performing signature-independent system behavior-based malware detection in accordance with one embodiment of the invention. The method steps of FIG. 3 will be described as being performed by components of the system of FIGS. 1 and 2. The method begins at “Behavior Analysis Module Enabled in Platform?” decision point 302. If behavior analysis module 240 is not enabled in platform 200, the process ends. If behavior analysis module 240 is enabled, control proceeds to “Load the Policy Settings from Secure Storage” step 304. Policy settings for expected activity levels for different resources, such as processor 210 and battery 250, are established for different modes of operation and stored in a policy database in secure storage 232. These policy settings are loaded into memory, and behavior analysis module 240 proceeds to “Obtain the Current Mode of Operation of the Platform from the Power Manager” step 306. Behavior analysis module 240 obtains the current mode of operation from mobile OS 205 power manager 207. On an ongoing basis, mobile OS 205 power manager 207 notifies behavior analysis module 240 if there is a change in the platform mode of operation, as shown in “Power Manager Notifies Behavior Analysis Module upon Change in Platform Mode of Operation” step 308.

From “Obtain the Current Mode of Operation of the Platform from the Power Manager” step 306, control proceeds to “Based on the Mode of Operation, Determine the Processes that are Expected to be Active for the Corresponding Mode” step 310, where behavior analysis module 240 identifies at least one process expected to be active based upon the current mode of operation of platform 200. Control proceeds to “Calculate the Expected Activity Level (Approximate Processor Frequency and Battery Consumption) for the Current Mode of Operation” step 312, where behavior analysis module 240 calculates the expected activity level of resources of platform 200 given the current mode of operation. For example, an approximate processor frequency and level of battery consumption may be calculated. Control then proceeds to “Monitor for Deviations in Actual Activity Level from Expected Activity Level” step 314. In step 314, behavior analysis module 240 monitors actual activity level for deviations from expected activity level. For example, processor monitor 241 monitors for deviations in processor frequency, privilege duration, and usage duration from expected activity levels. Battery monitor 242 monitors for deviations in battery usage from expected battery consumption. Wake event monitor 243 monitors for an unexpected number of wake events given the current mode of operation using System Controller Unit (SCU) 208.

Control proceeds from “Monitor for Deviations in Actual Activity Level from Expected Activity Level” step 314 to “Any Deviations Detected?” decision point 316. If no deviations are detected, control proceeds to “Take Snapshot of the System and Log Snapshot” step 322, where a snapshot of the system is taken and written to a log by communication/logging agent 244. The amount of data collected for a snapshot and the frequency at which snapshots are taken is implementation-specific and may be determined by original equipment manufacturers/original device manufacturers (OEM/ODMs). In one embodiment, the snapshot of a system may be analyzed by the remote server and virus signature matching may be performed at the remote server, thereby requiring fewer resources for signature processing on the client processing system.

If deviations are detected at “Any Deviations Detected?” decision point 316, control proceeds to “Identify Source of Unexpected Activity Level” step 318. At step 318, a source of the unexpected activity level, such as a source of the unexpected processor frequency, is identified as a potential source of the deviation. Control then proceeds to “Use Policy Guidelines to Determine Whether Unexpected Activity is Legitimate” step 320. As described above, once the source of unexpected activity is identified, behavior analysis module 240 uses policy guidelines to determine whether the unexpected activity is legitimate. For example, policy guidelines may be configured such that an application must be signed in order to be considered legitimate. Policy guidelines may be configured such that a user is alerted about the unexpected activity and user feedback is obtained to determine whether the application is legitimate. Control proceeds to “Legitimate Activity?” decision point 322. If the unexpected activity is determined to be legitimate, control proceeds to “Take Action According to Policy Settings” step 326. For example, additional monitoring routines may be invoked to monitor the application that is the source of the unexpected activity.

At “Legitimate Activity?” decision point 322, if the unexpected activity is determined to be not legitimate, control proceeds to “Classify Source of Unexpected Activity as Malware” step 324, where the source of unexpected activity is classified as malware. Control then proceeds to “Take Action According to Policy Settings” step 326, where appropriate action is taken to address the malware, such as terminating the source of unexpected activity levels and/or notifying a remote server with a system snapshot. Control then proceeds to “Take Snapshot of the System and Log Snapshot” step 328, where a snapshot of the system is taken and written to a log by communication/logging agent 244.

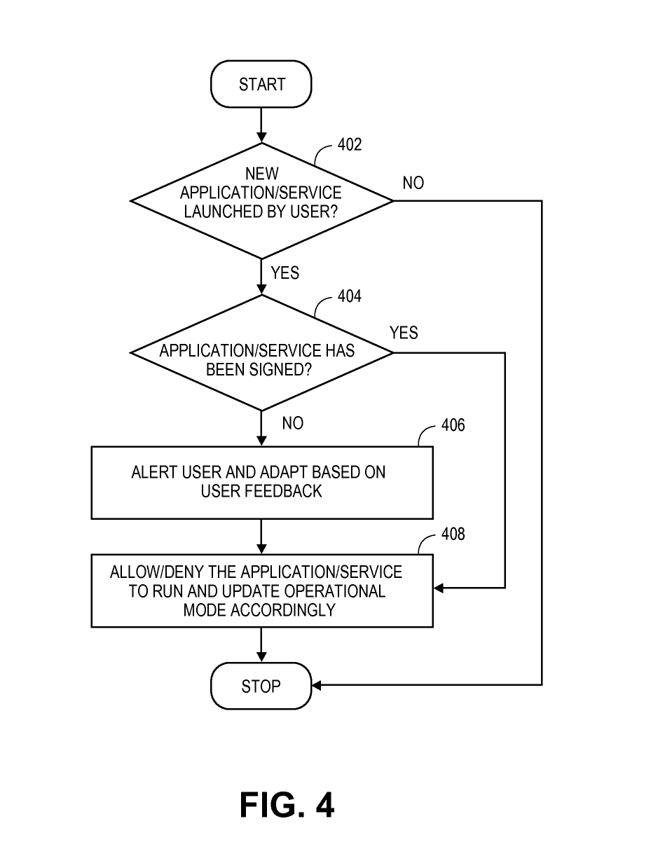

FIG. 4 is a flowchart of a method for monitoring new applications invoked by the user while the system is in operation in accordance with one embodiment of the invention. At “New Application/Service Launched by User?” decision point 402, behavior analysis module 240 determines whether a new application or service has been launched by a user of platform 200. If no new application or service has been launched, the process ends. If a new application or service has been launched, control proceeds to “Application/Service has been Signed?” decision point 404. If the application or service has been signed, control proceeds to “Allow/Deny the Application/Service to Run and Update Operational Mode Accordingly” step 408. Behavior analysis module 240 either allows or denies the application or service the opportunity to run and updates the operational mode accordingly.

At “Application/Service has been Signed?” decision point 404, if the application or service has not been signed, control proceeds to “Alert User and Adapt Based on User Feedback” step 406. The user is alerted via behavioral analysis module user interface 212, and behavior analysis module 240 adapts its behavior in accordance with the user feedback. For example, the user may override a requirement that all applications and services are signed and provide an instruction to allow the application to run even though it is unsigned. Alternatively, behavior analysis module 240 may notify the user that unsigned applications are not allowed. From “Alert User and Adapt Based on User Feedback” step 406, control proceeds to “Allow/Deny the Application/Service to Run and Update Operational Mode Accordingly” step 408. Behavior analysis module 240 either allows or denies the application or service the opportunity to run and updates the operational mode accordingly.

The process described with reference to FIG. 4 may be performed upon launching of a new application or whenever a determination is made that a deviation in the actual activity level from the expected activity level has occurred. The process described with reference to FIG. 4 may be used to determine whether the unexpected activity is legitimate.

The techniques described for signature-independent system behavior-based malware detection herein provide several advantages when compared to traditional malware detection methods. Because malware detection is performed without examining software programs for millions of malware signatures, significant storage and computing resources are saved. The behavior analysis module described herein leverages the mode of operation of the processing system as well as the activity level of resources such as processor(s) and battery to proactively identify malware. Because the behavior analysis module dynamically adapts when the mode of operation changes, false alarms are avoided. The behavior analysis module also takes into account whether an application or service is signed in analyzing its behavior.

The behavior analysis module described herein is configurable and policy-based. The behavior analysis module has the ability to take snapshots of the system and provide the snapshots to a remote enterprise server for verification purposes.

In addition, the behavior analysis module described herein operates in a secure environment isolated from an operating system for the processing system. This ensures that behavior analysis data is not accessible to untrusted parties, including the user, operating system, host applications, and malware. Policy settings and transaction logs are stored in the tamper-proof secure storage as well. Policies and alerts can be communicated securely from a remote enterprise server, thereby enabling the behavior analysis module to adapt to an ever-changing malware environment.

Embodiments of the mechanisms disclosed herein may be implemented in hardware, software, firmware, or a combination of such implementation approaches. Embodiments of the invention may be implemented as computer programs executing on programmable systems comprising at least one processor, a data storage system (including volatile and non-volatile memory and/or storage elements), at least one input device, and at least one output device.

Program code may be applied to input data to perform the functions described herein and generate output information. Embodiments of the invention also include machine-accessible media containing instructions for performing the operations of the invention or containing design data, such as HDL, which defines structures, circuits, apparatuses, processors and/or system features described herein. Such embodiments may also be referred to as program products.

Such machine-accessible storage media may include, without limitation, tangible arrangements of particles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash programmable memories (FLASH), electrically erasable programmable read-only memories (EEPROMs), magnetic or optical cards, or any other type of media suitable for storing electronic instructions.

The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The programs may be implemented in a high level procedural or object oriented programming language to communicate with a processing system. The programs may also be implemented in assembly or machine language, if desired. In fact, the mechanisms described herein are not limited in scope to any particular programming language. In any case, the language may be a compiled or interpreted language.

Presented herein are embodiments of methods and systems for performing signature-independent system behavior-based malware detection. While particular embodiments of the present invention have been shown and described, it will be obvious to those skilled in the art that numerous changes, variations and modifications can be made without departing from the scope of the appended claims. Accordingly, one of skill in the art will recognize that changes and modifications can be made without departing from the present invention in its broader aspects. The appended claims are to encompass within their scope all such changes, variations, and modifications that fall within the true scope and spirit of the present invention.

What is claimed is:

1. A computer-implemented method comprising:
identifying at least one process expected to be active for a current mode of operation of a processing system comprising one or more resources;
calculating an expected activity level of the one or more resources of the processing system based upon the current mode of operation and the at least one process expected to be active;
determining an actual activity level of the plurality of resources;
if a deviation is detected between the expected activity level and the actual activity level, identifying a source of unexpected activity as a potential cause of the deviation;
using policy guidelines to determine whether the unexpected activity is legitimate; and
classifying the source of the unexpected activity as malware if the unexpected activity is not legitimate.

2. The method of claim 1 further comprising:
sending a snapshot of the processing system to a remote server, wherein the remote server performs validation of the snapshot.

3. The method of claim 1 further comprising:
sending a snapshot of the processing system to a remote server, wherein the remote server analyzes the snapshot for virus signatures.

4. The method of claim 1 further comprising:
terminating the source of the unexpected activity.

5. The method of claim 1 further comprising:
identifying a change in the current mode of operation of the processing system to a new mode of operation;
identifying a second at least one process expected to be active; and
adjusting the expected activity level based upon the new mode of operation and the second at least one process expected to be active.

6. The method of claim 1 wherein
using the policy guidelines to determine whether the unexpected activity is legitimate comprises determining whether the source is signed.

7. The method of claim 1 wherein
using the policy guidelines to determine whether the unexpected activity is legitimate comprises:
alerting a user of the unexpected activity; and
obtaining feedback from the user about the unexpected activity.

8. A system comprising:
at least one processor; and
a memory coupled to the at least one processor, the memory comprising instructions that, when executed, cause the processor to perform the following operations:
identifying at least one process expected to be active for a current mode of operation of a processing system comprising one or more resources;
calculating an expected activity level of the one or more resources of the processing system based upon the current mode of operation and the at least one process expected to be active;
determining an actual activity level of the plurality of resources;
if a deviation is detected between the expected activity level and the actual activity level, identifying a source of unexpected activity as a potential cause of the deviation;
using policy guidelines to determine whether the unexpected activity is legitimate; and
classifying the source of the unexpected activity as malware if the unexpected activity is not legitimate.

9. The system of claim 8 wherein the instructions, when executed, further cause the processor to perform operations comprising:
sending a snapshot of the processing system to a remote server, wherein the remote server performs validation of the snapshot.

10. The system of claim 8 wherein the instructions, when executed, further cause the processor to perform operations comprising:
sending a snapshot of the processing system to a remote server, wherein the remote server analyzes the snapshot for virus signatures.

11. The system of claim 8 wherein the instructions, when executed, further cause the processor to perform operations comprising:
terminating the source of the unexpected activity.

12. The system of claim 8 wherein the instructions, when executed, further cause the processor to perform operations comprising:
identifying a change in the current mode of operation of the processing system to a new mode of operation;
identifying a second at least one process expected to be active; and
adjusting the expected activity level based upon the new mode of operation and the second at least one process expected to be active.

13. The system of claim 8 wherein
using the policy guidelines to determine whether the unexpected activity is legitimate comprises determining whether the source is signed.

14. The system of claim 8 wherein
using the policy guidelines to determine whether the unexpected activity is legitimate comprises:
alerting a user of the unexpected activity; and
obtaining feedback from the user about the unexpected activity.

15. A computer program product comprising:
a computer-readable storage medium; and
instructions in the computer-readable storage medium, wherein the instructions, when executed in a processing system, cause the processing system to perform operations comprising:
identifying at least one process expected to be active for a current mode of operation of a processing system comprising one or more resources;
calculating an expected activity level of the one or more resources of the processing system based upon the current mode of operation and the at least one process expected to be active;
determining an actual activity level of the plurality of resources;
if a deviation is detected between the expected activity level and the actual activity level, identifying a source of unexpected activity as a potential cause of the deviation;
using policy guidelines to determine whether the unexpected activity is legitimate; and
classifying the source of the unexpected activity as malware if the unexpected activity is not legitimate.

16. The computer program product of claim 15 wherein the instructions, when executed, further cause the processing system to perform operations comprising:
sending a snapshot of the processing system to a remote server, wherein the remote server performs validation of the snapshot.

17. The computer program product of claim 15 wherein the instructions, when executed, further cause the processing system to perform operations comprising:
sending a snapshot of the processing system to a remote server, wherein the remote server analyzes the snapshot for virus signatures.

18. The computer program product of claim 15 wherein the instructions, when executed, further cause the processing system to perform operations comprising:
terminating the source of the unexpected activity.

19. The computer program product of claim 15 wherein the instructions, when executed, further cause the processing system to perform operations comprising:
identifying a change in the current mode of operation of the processing system to a new mode of operation;
identifying a second at least one process expected to be active; and
adjusting the expected activity level based upon the new mode of operation and the second at least one process expected to be active.

20. The computer program product of claim 15 wherein
using the policy guidelines to determine whether the unexpected activity is legitimate comprises determining whether the source is signed.

21. The computer program product of claim 15 wherein
using the policy guidelines to determine whether the unexpected activity is legitimate comprises:
alerting a user of the unexpected activity; and
obtaining feedback from the user about the unexpected activity.
